(19) United States
(12) Patent Application Publication
(10) Pub. No.: US 2026/0127200 A1
(43) Pub. Date: May 7, 2026

(54) AGENTIC TOOL MESH PLATFORM

(71) Applicant: HEWLETT PACKARD ENTERPRISE DEVELOPMENT LP, Spring, TX (US)

(72) Inventors: ANTONIO FIN, Milano (IT); GLYN BOWDEN, Spring, TX (US); Carlo Maria Eugenio Vaiti, Milano (IT); Ignacio Aldama Perez, Las Rozas (IT)

(21) Appl. No.: 18/938,874

(22) Filed: Nov. 6, 2024

(51) Int. Cl. G06F 16/33; G06F 40/205

(52) U.S. Cl. CPC G06F 16/334; G06F 40/205

(57) ABSTRACT

Systems and methods are provided for creation of project meshes by defining agentic tool instances that can be activated to access agentic tools. Examples include providing an interface for defining a mesh of agentic tools and receiving, via the interface, queries descriptive of a project. The queries can be provided to a reasoning engine that generates first parameters defining tasks and second parameters defining agentic tool instances. The agentic tool instances can be created in accordance with the first parameters and the second parameters and activated for accessing agentic tools located in a data store. The agentic tools can correspond to a parameter of the first parameters associated an agentic tool instance. Examples can configure the mesh comprising the agentic tool instances, and the mesh can be executed to cause the agentic tool instances to access and run one or more of the agentic tools.

### BACKGROUND

Generative artificial intelligence (AI) is AI capable of generating text, images, videos, or other data using generative models, in some cases based on prompts. Generative AI models can learn patterns and structure of input training data and use the learned patterns and structure to generate new data that has similar characteristics. Improvements in transformer-based deep neural networks, such as large language models (LLMs), have enabled the advancement of generative AI systems, such as chatbots (e.g., ChatGPT, Copilot, Gemini, LLaMA, and the like), text-to-image generation systems (e.g., Stable Diffusion, Midjourney, DALL-E, and the like), and text-to-video generation systems (e.g., Sora and the like).

LLMs are computational models capable of language generation or other natural language processing tasks. As language models, LLMs acquire these abilities by learning statistical relationships from vast amounts of input data, such as text, during training. LLMs can provide predictive power regarding syntax, semantics, and ontologies contained in human language.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a schematic diagram of an example architecture of a project mesh creation system, in accordance with examples of the present disclosure.

FIG. 2 illustrates a schematic diagram of a project mesh task that can be constructed by the system of FIG. 1, in accordance with an example disclosed herein.

FIG. 3 depicts an illustrative example of project mesh that can be created by the system of FIG. 1, in accordance with an example disclosed herein.

FIG. 4 illustrates an example process for creating a project mesh, in accordance with the examples disclosed herein.

FIG. 5 is an example computing component that may be used to implement various features of creating a project mesh in accordance with the implementations disclosed herein.

FIG. 6 is an example computing component that may be used to implement various features of the system of FIG. 1 in accordance with the implementations disclosed herein.

FIG. 7 is a computing component that may be used to implement examples of the disclosed technology.

The figures are not exhaustive and do not limit the present disclosure to the precise form disclosed.

### DETAILED DESCRIPTION

Examples of the presently disclosed technology provide a platform (referred to herein as an agentic tool mesh platform) that supports creation of project meshes by defining a set of agentic tool instances, each of which can be activated (e.g., executed) to access an agentic tool. Examples herein can provide an interface for defining a project mesh as a mesh of agentic tools. The interface can receive queries descriptive of a target project and these queries can be used by the examples disclosed herein to create a project mesh for the project. In examples, the queries can be processed to generate parameters defining tasks of the project. Examples herein can discover agentic tools that can be utilized to perform the various tasks and create a set of agentic tool instances in accordance with the generated parameters. The agentic tools, in some examples, may themselves may be meshes designed for executing designed tasks. Examples herein can construct the project mesh by configuring the set of agentic tool instances to form a project mesh of the agentic tools assigned thereto. The project mesh can then be deployed as a standalone product that exposes its information and location for usage via an interface, such as but not limited to application programming interfaces (APIs) and/or user interfaces (UIs).

Conventional, monolithic AI solutions may be inflexible and fail to address unique needs of different domains. This lack of adaptability can lead to inefficiencies that may hamper an ability to leverage AI's full potential. Monolithic AI solutions, such as larger domain agnostic LLMs (e.g., the GPT series of models, Gemini, the LLaMA family of models, Granite models, Claude models, and Mistral AI's models, to name a few examples) may rely on a corpus of training data from a multitude of sources across various different domains to represent the corpora of human language. Due to the reliance on training data from numerous domains, domain agnostic LLMs may inhere inaccuracies and biases present in the data from which they are trained. Furthermore, what is true to one domain may not be true to another domain, but monolithic AI solutions may be incapable of distinguishing between different domains and may adaptable to pivot between domains.

Accordingly, examples herein leverage domain-specific agentic tools, each of which can be trained for a specific, domain centric task. Domain-specific agentic tools can provide for decentralized ownership of agentic tools among various creators. Each creator can oversee an agentic tool lifecycle of a particular domain-specific agentic tool, which can provide for coordination across multiple phases from development to deployment. Thus, each agentic tool can be finely tuned to meet the needs of its domain, whether the domain is customer service, research and development, or other areas. Each agentic tool can be deployed as a standalone product (e.g., a web application executable from a browser) through an API that exposes its information and endpoints for integration and usage. This setup can allow for creation of project meshes through orchestration of a mesh of domain-specific agentic tools. For instance, a chatbot agentic tool can be developed to interface with product documentation and execute tasks through software code, managed by a dedicated team responsible for integration and quality of that particular software code. In this example, a separate dedicated team may be responsible for the chatbot agentic tool.

The agentic tool mesh platform, according to examples disclosed herein, can incorporate a robust infrastructure that can provide an interface for agentic tool creators (referred to herein as “creator”) to independently develop, deploy, and manage particular project meshes. The term creators, as used herein, may refer to an individual creator or a team of creators, which need not be located at a common region. The agentic tool mesh platform can include frameworks that facilitate autonomy and innovation. For example, agentic tool instances that leverage prompt-based querying can be developed with minimal or no code experience, enhancing ease of creation. Additionally, the agentic tool mesh platform can provide machine learning operation (MLOps) agentic tools that can be executed to manage deployment infrastructure in production, which can ensure optimal performance for each project mesh. The agentic tool mesh platform can support orchestration of deployments across different computation machines (e.g., virtual machines or the like), accommodating varying computational, storage, and memory requirements, which can enhance scalability and efficiency.

The examples herein can provide for seamless interoperability and integration of multiple domain-specific agentic tools within a broader ecosystem. To achieve this, the agentic tool mesh platform can provide an interface and robust capabilities, including discoverability, security, understandability, and trustworthiness. Such features can ensure that the domain-specific agentic tools can operate not only autonomously but also synergistically with other domain-specific agentic tools, which can enhance overall system interoperability and user confidence.

Example herein may include a LLM-based reasoning engine that can orchestrate a plurality of agentic tools to form a mesh of agentic tools (i.e., a project mesh) using descriptions of project goals provided through prompts. For example, queries can be provided to the reasoning engine, which may apply an LLM thereto to parse the queries and generate parameters that can be used to discover agentic tools for achieving these goals. The examples herein can transform any queried project into the mesh of agentic tools by running an entry function that provides library functions that facilitate generative code development, such as, but not limited to, Retrieval-Augmented Generation (RAG) functionalities. Each agentic tool can follow a design pattern in which the LLM abstracts desired functionality while allowing the low-level implementation that best satisfies the use cases. For instance, some agentic tools can be implemented as utility functions that can simplify the complexities of underlying libraries, such as LangChain, Hugging Face, LLaMA Index, and the like. While other agentic tools can be implemented as domain-specific agentic tools for executing high-level functions that can address tasks unique to specific domains, such as, for example, parsing telecommunications standards using advanced techniques, as well as other applications.

In examples disclosed herein, a set of agentic tool instances can be meshed together to form an interworking collection of domain-specific agentic tools, referred to as a project mesh, that can be executed to perform tasks related to a project and obtain results related thereto. The agentic tool mesh platform, according to examples, provides an interface for the deployment of and orchestration of the project mesh. For instance, the interface may be used to define a plurality of agentic tool instances, each of which can be configured to access and execute an associated domain-specific agentic tool. The interface may also be used to construct the project mesh from the plurality of agentic tool instances.

As an illustrative example, a project mesh may be created that comprises a first agentic tool instance, a second agentic tool instance, and a third agentic tool instance. The first agentic tool instance may be executable to activate a RAG agentic tool (e.g., a first agentic tool) that can accept and parse queries provided in natural human understandable language. The second agentic tool instance may be used to obtain a result of a query requested through the chat-bot agentic tool by executing one or more sub-tasks on a second agentic tool comprising one or more domain-specific agentic tools. That is, for example, the second agentic tool may comprise a mesh of domain-specific agentic tools, which the second agentic tool instance may run by executing sub-agentic tool instances that each run an associated domain-specific agentic tool of the mesh. The third agentic tool instance may be dedicated for formatting and returning results in a human readable manner. As another example, the first agentic tool instance may be a RAG agentic tool that retrieves information from product documentation; the second agentic tool instance may be an agentic tool with an embedded agent that interacts with the project's API to collect real-time data; and the third agentic tool instance may be an agent that uses an LLM to interpret the data, converting the data into a semantic state representation.

Examples disclosed herein may leverage a prompt-based interface to construct the project mesh with minimal to no coding necessary on the part of the creator, thereby enhancing creation and user acceptance through ease of use. For example, a plurality of natural language queries may be entered into a user interface by a creator, for example, in the form of a character string or spoken language. The queries may be descriptive of a project, including, among other things, references to certain roles, goals, and other information describing the project. The queries can be used to locate agentic tools that can be configured into a mesh for performing tasks of the project to achieve the specified goals.

In an example, the prompt-based interface may facilitate defining the set of agentic tool instances constituting the project mesh for a project having an ultimate goal of creating the project mesh as a product. In this case, queries can be provided to the agentic tool mesh platform, which can generate a plurality of first parameters defining tasks of the project and a plurality of second parameters defining a set of agentic tool instances for handling the tasks. The set of agentic tool instances can be created using the plurality of first parameters and the plurality of second parameters. Each of the set of agentic tool instances can be activated for accessing an agentic tool, which may be located in an external location. In examples, the agentic tool for each agentic tool instance may correspond to a first parameter of the plurality of first parameters associated with the respective agentic tool instance (e.g., a first parameter defining the task for the respective agent). In this way, each task defined by the plurality of first parameters can be assigned an agentic tool instance of the set of agentic tool instances, which is configured to access a corresponding agentic tool.

In examples, a project mesh can be configured that comprises the set of agentic tool instances. For example, the set of agentic tool instances and corresponding agentic tools may define the project mesh. Configuring the project mesh may include populating fields of a configuration file for the project mesh using the plurality of first parameters and the plurality of second parameters to define the set of agentic tool instances. Additionally, fields of the configuration file associated with each agentic tool instance of the set of agentic tool instances can be populated with information referencing an agentic tool corresponding to a respective agentic tool instance. Running the project mesh may be performed by executing a mesh function that runs the configuration file, which causes one or more agentic tool instances of the set of agentic tool instances to access and run its respective agentic tools in accordance with inquiries provided to the mesh function.

In an example, a set of agentic tool instances may comprise a first, second, and third agentic tool instance created for performing a first, second, and third task, respectively. The first task, in this example, may be provided having a description of planning an execution of agentic tools and an expect output of orchestrating (e.g., setting an order of) the execution. The first agentic tool instance, in this example, may be created having a role of Planner and a goal of orchestrating (e.g., setting an order of) the execution. The second task, in this example, may be provided having a description of executing call functions for each agentic tool and an expect output of calling outputs of each agentic tool. The second agentic tool instance may be created having a role of Controller and a goal of controlling the execution of the set of agentic tool instances to obtain results from each. The third task, in this example, may be provided having a description of formatting and reporting project results and an expect output in accordance with such. The third agentic tool instance may be created having a role of Reporter and a goal of formatting and presenting results from the execution of the agentic tools by the second agentic tool instance. The second agentic tool instances, in this example, may call a subset of agentic tool instances for executing desired tasks. The subset of agentic tool instances may each access and run associated agentic tools that can be domain-specific to the task that the respective agentic tool instance is called to execute.

In an example, the agentic tool mesh platform can comprise an LLM that uses natural language processing and prompt-engineering to parse queries and generate the first and second plurality of parameters. In this example, the agentic tool mesh platform can populate the configuration file with the plurality of the first and second parameters. In some examples, the agentic tool mesh platform can include a chatbot interface that provides prompts to a creator to illicit queries. In this case, the LLM may assist with defining the parameters by generating and posing questions as prompts in the chatbot interface. Additionally, the agentic tool mesh platform may retrieve lists of available agentic tools for a given task, which can be presented via the chatbot interface, which may prompt the creator to select desired agentic tools. In some examples, the LLM may recommend agentic tools and/or be prompted by the creator to recommend agentic tools.

In summary, a creator can enter natural language queries descriptive of a project, which the examples herein can parse to construct a mesh of agentic tools for providing results for a target project. The agentic tools can be accessed by a set of agentic tool instances that are grouped together in a configuration file to form the project mesh. In this case, the creator may submit natural language queries to the interface, which can be provided to the agentic tool mesh platform. The agentic tool mesh platform can parse the natural language queries to generate parameters and locate agentic tools in accordance with the parameters. Externally stored agentic tools can be selected as agentic tools for the project mesh and the agentic tool mesh platform can populate a configuration file with a set of agentic tool instances defined by the parameters for accessing and running the agentic tools. The configuration file may be stored as the project mesh of the target project. By populating the configuration file with the set of agentic tool instances of the agentic tools, the examples herein can construct a project mesh that, when executed, can run a project mesh that provides outputs of the target project.

After the project mesh is constructed, a mesh function can be executed that runs the configuration file to access the project mesh. Executing the mesh function can cause the set of agentic tool instances to access and execute corresponding agentic tools to obtain results of the project. For example, a subsequent user (which may be the creator in some examples) may run the project mesh by entering natural language inquiries that, among other things, specifies the project and a desired result. The inquiries can be provided to the interface, via an input device, which identifies the project mesh and runs the project mesh in accordance the desired result. For example, the project mesh may parse the inquires to generate parameters that identify which agentic tools of the project mesh are needed to provide the desired result. The project mesh may then activate the agentic tool instances corresponding to the identified agentic tools in accordance with the queried desired result. Each agentic tool instance can be activated, either in a sequence defined by the creator during construction of the project mesh or in default order, as set forth by the agentic tool mesh platform, to access a corresponding agentic tool, which can be ran to execute an assigned task. Each agentic tool may execute its task according to the defined order to supply an output. The outputs can be processed to provide the output result in accordance with the desired result as specified in the inquiries.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.]

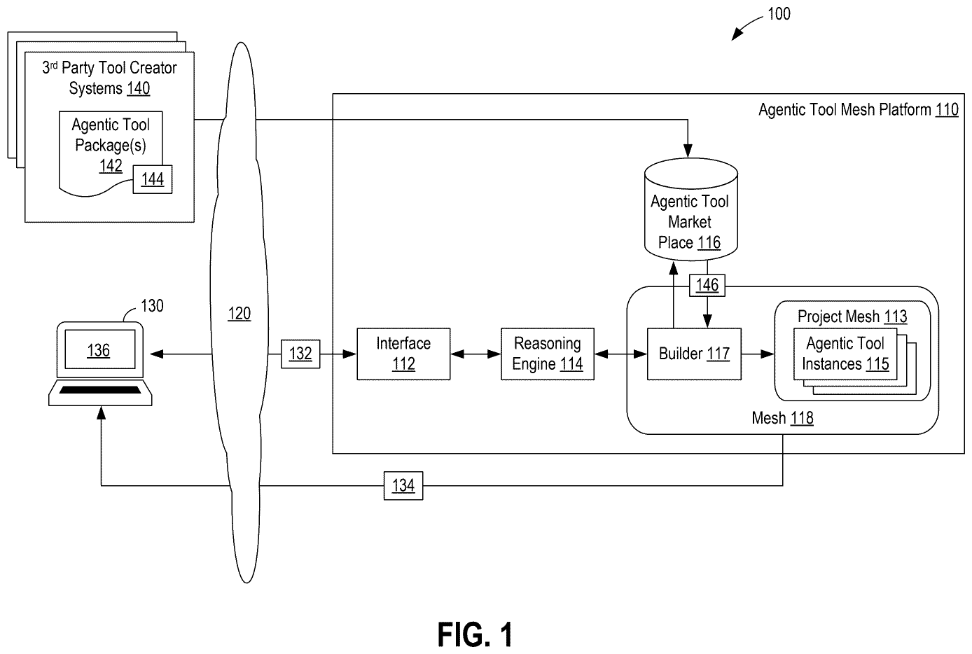

FIG. 1 is a schematic diagram of an example architecture of a system 100 in accordance with examples of the present disclosure. In the example of FIG. 1, system 100 comprises an agentic tool mesh platform 110 (referred to herein as platform 110) that be implemented on a server computer a collection of distributed server computers that communicates via network communications to other devices accessible on network 120, including client system 130 and third party tool creator systems 140. The platform 110 comprise an interface 112, a reasoning engine 114, and an agentic tool market place 116.

In examples, platform 110 may comprise an interface 112 for defining a mesh 118 of agentic tools. For example, interface 112 may receive one or more queries descriptive of a target project seeking to construct a mesh 118. The interface 112 may provide the one or more queries to a reasoning engine 114 that may be configured to generate a plurality of first parameters defining tasks of the project and a plurality of second parameters defining a set of agentic tool instances 115 for the tasks. The reasoning engine 114 provides the plurality of first parameters and the plurality of second parameters to a builder 117, which can construct a project mesh 113 comprising set of agentic tool instances 115. In examples, the builder 117 and project mesh 113 make up the mesh 118, such that the project mesh 113 is a subset of the entire mesh 118. A client system may execute the project mesh 113 to use those agentic tool instances 115 specified in the project mesh 113.

In an example, builder 117 may be configured to create project mesh 113 as the set of agentic tool instances 115 in accordance with the plurality of first parameters and the plurality of second parameters and activate each of the set of agentic tool instances 115 for accessing an agentic tool located in an external data store (e.g., at third party tool creator systems 140). The agentic tool for each agentic tool instance 115 may correspond to a first parameter of the plurality of first parameters associated with the respective agentic tool instance. The builder 117 may also be operated to configure the project mesh 113 comprising the set of agentic tool instances 115, such that executing the project mesh 113 causes each agentic tool instance to access and run its respective agentic tool.

In example, the builder 117 may be a default (or initial) project mesh that is configured to construct the project mesh 118 in accordance with the plurality of first parameters and the plurality of second parameters. For example, the builder 117 may be a mesh comprising one or more agentic tool instances (e.g., sub-agentic tool instances), such as but not limited to: a first agentic tool configured to connect to the agentic tool market place 116, retrieve available agentic tool packages, and recommend suitable tools based on the first plurality of parameters; a second agentic tool configured to configure agentic tool settings, for example, based on the second plurality of parameters; a third agentic tool configured to facilitate loading data (e.g., for RAG tools); a fourth agentic tool configured to facilitate defining a user interface for the mesh 118, if needed; a fifth agentic tool configured deploy resources for the agentic tools constituting the project mesh 113 and other mesh services; and a sixth agentic tool configured to expose endpoints (e.g., API and UIs) and bind the agentic tools to the mesh 118.

As noted above, each agentic tool instance 115 may be created to access and its respective agentic tools. For example, a first agentic tool instance may execute an agentic tool that performs a database query, while agentic tool instance executes an agentic tool for performing one or more API calls. The API calls may cause other agentic tools to be executed, such as other machine learning models and LLMs (e.g., domain-specific LLMs and the like. There could be any number of such agentic tool instances 115 accessing any number of different agentic tools.

The set of agentic tool instances 115 can be assigned appropriate agentic tools of the project mesh 113 to accomplish defined tasks (e.g., tasks defined by the reasoning engine 114). The agentic tools can make the appropriate function calls to retrieve disparate data records among other functions. As used herein, data records can include unstructured data records (e.g., documents and text data that is stored on a file system in a format such as PDF, DOCX, .MD, HTML, TXT, PPTX, image files, audio files, video files, application outputs, and the like), structured data records (e.g., database tables or other data records stored according to a data model or type system), time series data records (e.g., sensor data, artificial intelligence application insights), and/or other types of data records (e.g., access control lists). The agentic tool instances 115 can transform the disparate data records into a common format (e.g., natural language format) that can be post-processed by the reasoning engine 114 (e.g., by a LLM) or another agentic tool instance executing an LLM or domain-specific LLM. Various types of agentic tools may be implemented in the examples disclosed here. Examples types include, but are not limited to, multi-agentic tools; RAG tools; LLM-based agentic tools (e.g., copywriting tools that improves text, code generation tool for data analysis, etc.); and agentic tools that execute codes to call APIs, to name a few examples.

In more detail, the platform 110 may operate as a central hub that leverages reasoning engine 114 and builder 117 for creating project meshes from various agentic tools packages 142 that are accessible via an agentic tool market place 116. As used herein, any agentic tool may refer to a piece of an agentic tool package, which may be a project mesh created by a third party. In some cases, an agentic tool that that is part of a project mesh (e.g., created via platform 110), may also comprise or otherwise reference one or more agentic tools of its own. In examples, the platform 110 may operate reasoning engine 114 and builder 117 to create the project mesh 113 by orchestrating various agentic tools into a mesh of agentic tool instances 115 executable to access and run corresponding agentic tools. The agentic tools may be agentic tools packages 142 that are stored at data stores associated with third party tool creator systems 140, which may expose information and location of each agentic tool 142 for usage via APIs 144.

Each agentic tool packages 142 can include one or more agentic tools for performing specific functions and/or machine learning models to accomplish a given task (or set of tasks). Machine learning models can include one or more of different types or modalities of models (e.g., multimodal machine learning models, large language models, data models, statistical models, audio models, visual models, audiovisual models, etc.). In examples, agentic tools packages 142 may comprise one or more domain-specific agentic tools trained for a specific, domain centric task. Examples agentic tools may include, but not limited to, chatbot agentic tools developed to interface with product documentation and execute tasks through software code, managed by a dedicated team responsible for its integration and quality, agentic tools offering RAG functionalities, and the like. Domain-specific agentic tools can include functions for addressing a specific domain (e.g., field), such as but not limited to, parsing telecommunications standards using an LLM and/or RAG, parsing network status, parsing network configurations, document retrieval, parsing weather status and forecast, and so on. Agentic tools may also include utility functions that can simplify the complexity of underlying libraries, such as LangChain, Hugging Face, and LLaMA Index.

Agentic tool packages 142 can include, among other things, a manifest that sets forth a description (e.g., a role, goal, context, and/or backstory) of a respective agentic tool package 142, expected input arguments/queries, and expected output(s) for each respective agentic tool package 142. In examples, each agentic tool package 142 can include code embodying the agentic tool package 142, such as, but not limited to, a Python package, Docker image, and the like. Additionally, each agentic tool package 142, in some examples, can include default settings, such as default code settings and settings to be utilized by the platform 110. In the case that an agentic tool package 142 comprises a plurality of tools, the agentic tool package 142 may include the above information for each agentic tool.

The agentic tool market place 116 may store references to various agentic tool packages, such as agentic tool package(s) 142 created by third party tool creator systems 140. The agentic tool packages referenced in the agentic tool market place 116 may be utilized as agentic tools by the platform 110 for creating the project mesh 113. The agentic tool market place 116, in examples, provides listings of agentic tool packages that are available to the platform 110. Each agentic tool packages can be deployed as a standalone product (e.g., a web application executable from a browser) through an API that exposes its information and endpoints via the agentic tool market place 116 for integration and usage by platform 110. When deployed by the platform 118, an agentic tool package becomes an agentic tool instance. The agentic tools themselves, constituting an agentic tool package, may be located on other devices, such as data stores or devices operated under third party tool creator systems 140. This setup can provide for decentralized ownership of agentic tools among various third party tool creator systems 140. Each third party tool creator systems 140 can oversee a lifecycle of a particular agentic tool, which can provide for coordination across multiple phases from development to deployment.

The interface 112 may provide for communication with client system 130 via network 120. In examples, interface 112 may be an API gateway through which client system 130 may be provided access to a dashboard 136, hosted by the platform 110, via a web portal or web application executable from a browser running on client system 130. The interface 112 may receive one or more queries descriptive of a project, which the interface 112 may provide to the reasoning engine 114. Information may be input into and/or presented on the interface 112 by the client system 130 via an input device (e.g., alphanumeric and other keys, mouse, a trackball, touch screen, microphone, and the like). In some examples, interface 112 be configured as a chatbot interface that can receive queries from the client system 130. In examples, the chatbot interface can provides prompts to client system 130, which may be based on (e.g., responsive to) queries from client system 130, to illicit further queries from the client system 130.

The platform 110 can transmit data and information to the client system 130, which can be presented via the dashboard 136. For example, platform 110 may generate a graphical user interface (GUI), via interface 112, which can be displayed on the client system 130. The one or more queries can be input into the GUI and provided to the platform 110 through the interface 112. In the case of a chatbot interface, the GUI may display a search field into which the one or more queries can be input. The GUI may also display a chat window that may present prompts from the platform 110 that are responsive to queries input into the search field and/or to illicit further queries as described herein.

The reasoning engine 114, in examples, may receive the queries 132 from the interface 112 and generate parameters based on the queries. For example, reasoning engine 114 may generate a plurality of first parameters defining tasks of the project and a plurality of second parameters defining a set of agentic tool instances for the tasks. In an example, reasoning engine 114 may be an LLM-based reasoning engine that executes an LLM to parse the queries and generate the plurality of first and second parameters. The LLM-based reasoning engine uses natural language processing and prompt-engineering to interpret the one or more queries, parse, and recognize features from the queries descriptive of tasks and agentic tool instances. Based on the recognized features, the LLM may generate the plurality of first parameters that can be used to define tasks and the second plurality of parameters that can be used to define agentic tool instances that can be assigned to each task.

In an example, the plurality of first parameters may comprise sets of task parameters, each of which can be used to define a task. Each set of task parameters may include a first one or more parameters representative of a task description and a second one or more parameters descriptive of expected outputs for a task. Each first one or more parameters may be associated with a second one or more parameters, such that each expected output is associated with a task description. Thus, the reasoning engine 114 can define a given task of the project using a set of parameters.

The builder 117 can be configured to create a set of agentic tool instances 115 and assign an agentic tool instance of the set of agentic tool instances 115 (referred to herein collectively as agentic tool instances or set of agentic tool instances 115 and individually as an agentic tool instance 115) to each defined task. The set of agentic tool instances 115 can be created using the plurality of first parameters and the plurality of second parameters. For example, the plurality of second parameters may be used by the builder 117 to define agentic tool instances 115, which can be assigned to tasks according a correspondence with the plurality of first parameters. That is, for example, the plurality of second parameters may comprise sets of agentic tool instance parameters, where each set defines an agentic tool instance 115. Each set of agentic tool instance parameters can be assigned to a set of task parameters of the plurality of first parameters according to relation between the agentic tool instance parameters and the task parameters. For example, a set of agentic tool instance parameters may include a first one or more parameters representative of a role for an agentic tool instance 115, a second one or more parameters representative of a goal for the agentic tool instance 115, and a third one or more parameters representative of a backstory (e.g., context of the desired usage for the LLM) for the agentic tool instance 115. An agentic tool instance 115 can be assigned to a task in which the role corresponds to (e.g., is substantially related to or otherwise similar to) the description of the task and the goal corresponds to the expected output of the task. In some cases, the role and the description may be the substantively the same, and the goal and the expected output may be substantively the same.

The builder 117 may be configured to discover candidate agentic tools from the agentic tool market place 116 based on the plurality of first parameters and/or the plurality of second parameters. For example, the builder 117 may access the agentic tool market place 116 and locate one or more of agentic tools packages 142 referenced in the agentic tool market place 116 that may be useful in performing a defined task. In an example, the set of task parameters (e.g., the task description and expected outputs) may be used by the builder 117 to locate agentic tool packages as candidates for performing the described task. In another example, the set of agentic tool instance parameters (e.g., the role and goal), alone or in combination with task parameters, may be used by the builder 117 to locate agentic tool packages 142. In any case, builder 117 may retrieve a plurality of agentic tool packages 146 that are candidates for each task. The plurality of agentic tool packages 146 may comprise a listing of one or more agentic tools packages applicable to each defined task.

In examples, the plurality of agentic tool packages 146 may be provided as a listing of references to the various agentic tool packages. For example, as alluded to above, the agentic tool market place 116 comprises references to the various agentic tool packages 142. The references may include, among other things, a name or other identifiers of each agentic tool packages 142 and a location at which the agentic tool package 142 is stored. The location (or pointer) may be an endpoint exposed by an API of each agentic tool package 142. In examples, the location may be provided as an IP address where the agentic tool package 142 is located and can be accessed (e.g., as a web application executable from a browser) or a file location. File locations may be useful, for example, where the agentic tool will be accessed locally with respect to the project mesh that is ultimately created. The plurality of agentic tool packages 146 may be provided as a listing of references containing this information for locating and executing each respective agentic tool at a specified location.

The builder 117 may allocate one or more agentic tool packages of the plurality of agentic tool packages 146 to each defined task as one or more agentic tools. In an example, the builder 117 may select one or more optimal agentic tool packages as one or more agentic tools for a given task, for example, in accordance with the plurality of first and/or second parameters. In another example, builder 117 may forward the plurality of agentic tool packages 146 to the client system 130, via reasoning engine 114 and interface 112, for selection by a creator. In this case, the plurality of agentic tool packages 146 can be presented via the dashboard 136 for selection. In the case where there interface 112 is implemented as chatbot, the interface 112 may recommend agentic tools and/or be prompted by the creator to recommend agentic tools for each defined task.

Once the one or more of the agentic tool packages 146 are allocated to a defined task, the builder 117 may deploy the allocated agentic tool packages 146 on the platform 110 as one of agentic tool instances 115. Deploying an agentic tool package 146, may include updating, by builder 117, default settings specified by the third party tool creator based on the plurality of second parameters. Builder 117 may also allocate resources that may be necessary to run the allocated agentic tool packages 146 and services of the 110 (e.g., LLM, databases, etc.). The builder 117 may then expose API endpoints and UIs (if any), as defined by the third party creator. Builder 117 may then bind the agentic tool instance 115 (e.g., deployed agentic tool package 146) to mesh 118, for example, by populating the configuration file 134 as described below.

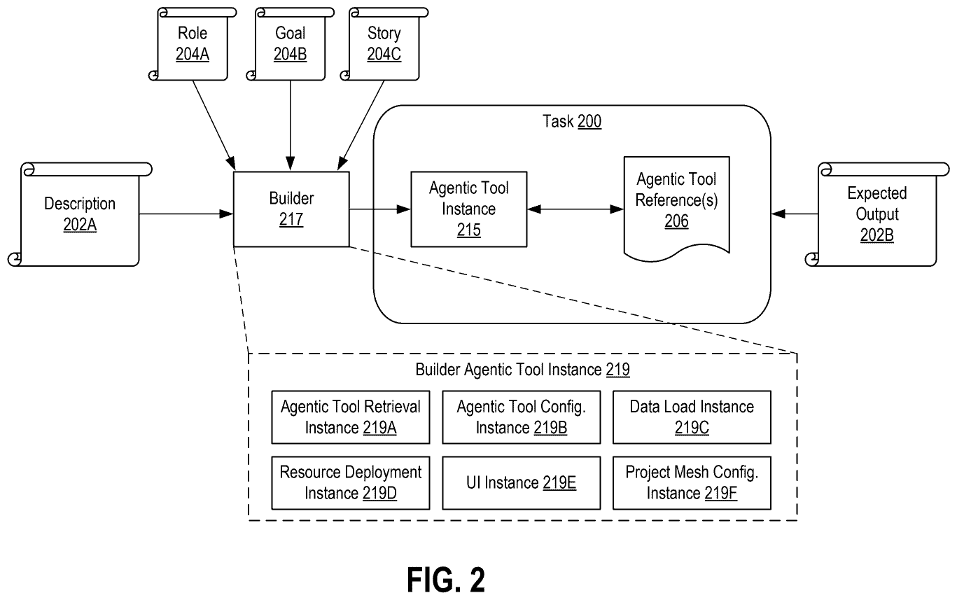

A schematic example of defining a task is shown in FIG. 2. For example, FIG. 2 illustrates a schematic diagram of a task 200 that can be constructed using system 100, in accordance with an example disclosed herein. Task 200 may be an example of a task that can be defined based on the one or more queries provided to the reasoning engine 114 of FIG. 1. For example, the interface 112 may provide the one or more queries to the reasoning engine 114, which generates a plurality of first and second parameters. In the example of FIG. 1, the plurality of first and second parameters can be provided to a builder 217 (e.g., an example implementation of builder 117) for constructing the task 200.

The plurality of first and second parameters may comprise sets of task and agentic tool instance parameters. In the example of FIG. 2, the set of task parameters of the plurality of first parameters are shown as parameters 202A and 202B, and the set of agentic tool instance parameters of the plurality of second parameters as parameters 204A-204C. As shown in FIG. 2, task 200 can be defined by a description parameter 202A and an expected output parameter 202B, while an agentic tool instance 215 for task 200 can be defined by role parameter 204A, goal parameter 204B, and backstory parameter 204C. As detailed above, the agentic tool instance 215 can be assigned to task 200 via a relation between parameters 204A and 202A and/or between parameters 204B and 204C.

In the example of FIG. 2, builder 217 comprises a plurality of agentic tools 219A-219F. Builder 217, in this example, includes agentic tool retrieval instance 219A configured to connect to the agentic tool market place (e.g., agentic tool market place 116), retrieve available agentic tool packages, and recommend suitable tools based on the first plurality of parameters. Builder 217 also includes agentic tool configuration instance 219B configured to configure agentic tool settings, for example, based on the second plurality of parameters, data load instance 219C configured to facilitate loading data (e.g., for RAG tools), resource deployment instance 219D configured to deploy resources for the agentic tools constituting the project mesh (e.g., project mesh 113) and other mesh services, a UI instance 219E configured to facilitate defining a user interface for a project mesh (if needed); and project mesh configuration instance 219F configured to expose endpoints (e.g., API and UIs) and bind agentic tools to the project mesh.

In operation, builder 217 may execute agentic tool retrieval instance 219A to connect to and discover candidate agentic tool packages from the agentic tool market place using parameters 202A and 202B and/or parameters 204A-204C. For example, the builder 217 may use the parameters 202A and 202B to locate one or more of agentic tools packages referenced in the agentic tool market place, which may be useful in performing task 200. In another example, the parameters 204A-204B, alone or in combination with task parameters 202A and 202B, may be used to locate agentic tool packages 142. In any case, agentic tool retrieval instance 219A may retrieve a plurality of agentic tool packages that are candidates for task 200 (e.g., agentic tool packages 146), one or more of which can be allocated to task 200, as described above.

Once allocated, builder 217 can deploy the allocated agentic tool package(s) as an agentic tool instance 215 for the task 200. The agentic tool instance 215 may contain references 206 containing information for locating and executing the corresponding agentic tool package at a specified location. The information may include, among other things, a name or other identifiers of the agentic tool packages, from which the agentic tool instance 215 was deployed, and a location at which the agentic tool package is stored for execution.

In an example, builder 217 can deploy the allocated agentic tool package(s) by executing its plurality of agentic tools 219B-219F. For example, builder 217 may execute agentic tool configuration instance 219B to configure settings of the agentic tool instance, for example, based on the parameters 204A-204C. For example, agentic tool configuration instance 219B may construct a manifest that includes parameters 204A-204C. Builder 217 may execute data load instance 219C to load any data needed by the agentic tool instance 215 (e.g., collections for RAG tools). Builder 217 may also execute resource deployment instance 219D to deploy and assign computation resources that may necessary for executing agentic tool instance 215. If a UI is needed for the particular agentic tool instance, as specified by the third party tool creator, builder 217 may execute UI instance 219E to define the UI. Builder 217 may then execute project mesh configuration instance 219F to bind the agentic tool instance 215 to the project mesh and expose its endpoints (e.g., API and UIs, if any) to other systems and/or agentic tool instances. An example of binding agentic tool instances is provide below with reference to populating a configuration file.

While FIG. 2 illustrates a single task 200 and assigned agentic tool instance 215 as defined by parameters 202A-204C, this is provided as an illustrative example. The implementations disclosed herein are not limited to this example alone. Each task and agentic tool instance may be defined in a similar manner. Thus, a plurality of first parameters, as described above, may comprise multiples of parameters 202A and 202B, one set for each task. Similarly, a plurality of second parameters, as described above, may comprise multiples of parameters 204A-204C, one set for each agentic tool instance.

Returning to FIG. 1, the builder 117, according to examples, can be operated to configure the project mesh 113 comprising the set of agentic tool instances 115 that can access and execute corresponding agentic tools and ultimately create project mesh 113. For example, the set of agentic tool instances 115 and corresponding agentic tools may define the project mesh 113 resulting from the project. Configuring the project mesh 113 may include building a configuration file 134 by the reasoning engine 114, for example, by populating fields of the configuration file using the plurality of first and second parameters. Additionally, fields of the configuration file 134 corresponding to each agentic tool instance 115 can be populated with information for accessing and executing a corresponding agentic tool. In examples, the configuration file 134 may be stored at client system 130, which can be executed to perform tasks of project mesh 113. Said another way, the configuration file 134 may define project mesh 113 as agentic tool instances 115 of mesh 118 (e.g., which can include both builder 117 and project mesh 113) and the client system 130 can use the configuration file 134 to execute one or more agentic tool instances 115 constituting project mesh 113. Thus, while the agentic tools that are executed as part of project mesh 113 are stored in distributed deployment via platform 110, the configuration file 134, which can be ran to execute the project mesh 113, can be stored elsewhere.

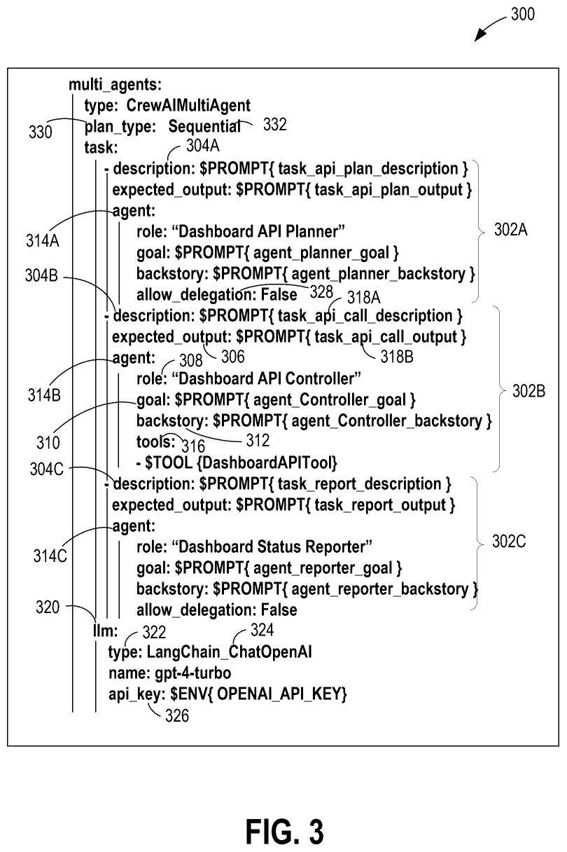

FIG. 3 depicts an illustrative example of a configuration file 300 that can be created via platform 110, in accordance with an example disclosed herein. The configuration file 300 (e.g., an example of configuration file 134 described above) is provided for illustrative purposes only and should not be interpreted as limiting the scope of the disclosed technology to only the depicted example. The configuration file 300 may construct a project mesh 113 as a multi-agentic tool instance mesh that sets forth a plurality of tasks 302A-302C (collectively referred to as tasks 302 or individually as a task 302), each delineated by a description field 304A-304C (collectively referred to as fields 304 or individually as field 304). Each task 302 can be defined by a plurality of fields. For example, referring to task 302B, a description field 304, expected output field 306, role field 308, goal field 310, and backstory 312. Each task 302 is assigned one of agentic tool instances 314A-314B, which are defined by role field 308, goal field 310, and backstory 312, and can be assigned an agentic tool via agentic tool(s) field 316.

As described above, the reasoning engine 114 of FIG. 1 can generate parameters that can be used by builder 117 to populate the various fields of each task. For example, with reference to task 302B, a set of task parameters may include first parameters 318A and 318B comprising $PROMPT{task_api_call_description} and second one or more parameters comprising $PROMPT{task_api_call_output}. Reasoning engine 114 may populate field 304B and 306 with the first and second one or more parameters, respectively. Similarly, reasoning engine 114 may populate the other fields with corresponding parameters. Additionally, a location at which the agentic tool selected for each agentic tool instance 314A-314C can be used to populate a corresponding agentic tool field, such as agentic tool field 316.

In the example of FIG. 3, there are three tasks 302A-302C. The task 302A, in this example, may be provided having a description of planning an execution of agentic tools and an expect output of orchestrating (e.g., setting an order of) the execution. The agentic tool instance 304A, in this example, may be created having a role of Planner and a goal of orchestrating (e.g., setting an order of) the execution. The task 302B, in this example, may be provided having a description of executing call functions for each agentic tool and an expect output of calling outputs of each agentic tool. The agentic tool instance 304B may be created having a role of Controller and a goal of controlling the execution of the set of agentic tool instances to obtain results from each. The task 302C, in this example, may be provided having a description of formatting and reporting project results and an expect output in accordance with such. The agentic tool instance 304C may be created having a role of Reporter and a goal of formatting and presenting results from the execution of the agentic tools by the second agentic tool instance. The agentic tool instance 304B, in this example, may call a subset of agentic tool instances for executing desired tasks. The subset of agentic tool instances may each access and run associated agentic tools that can be domain-specific to the task that the respective agentic tool instance is called to execute.

While three tasks are illustrated in FIG. 3, as noted above, this is an illustrative example. Additional or fewer tasks (and corresponding agentic tool instances) may be included in a configuration file, depending on the implementation and target project.

Additionally, FIG. 3 illustrates some additional functionality that builder 117 can support for creating the configuration file 300. For example, one or more LLM types may be specified within the configuration file. For example, as shown in FIG. 3 an LLM 320 may be defined by an LLM type field 322 populated by a parameter 324 (e.g., LangChain_ChatOpenAI) that specifies a selected LLM type. Other LLM types may be specified as desired (e.g., the GPT series of models, Gemini, the LLaMA family of models, Granite models, Claude models, and Mistral AI's models, to name a few examples). Field 322 may be used to select an LLM type that can be used by the reasoning engine 114 for parsing queries. In some examples, the LLM type may be selected at an early stage of the project, for example, prior to submitting queries for defining tasks. The location of the LLM (e.g., $ENV{OPENAI_API_KEY} in this example) can be used to populate a location (or point) filed 326 in the configuration file 300 for accessing the LLM.

As another example, each agentic tool instance can be permitted to delegate its role and/or goal to another agentic tool instance based on creator preferences. For example, a creator may specify whether delegation is allowed (TRUE) or not (FALSE) on a per-agentic tool instance or per-task basis. This parameter can be used to populate a delegation field, such as for example, delegation field 328 shown in task 302A as an example.

In various examples, the configuration file (e.g., configuration file 300 as an example) may set forth a sequence in which each task is to be performed. In the example of configuration file 300, a sequence field 330 (shown as “plan_type”) can be populated with a parameter 332 defining the sequence. In this example, the sequence field 322 is set to “sequential, which refers to executing the tasks in the sequential order set forth in the configuration file (e.g., task 302A, then task 302B, and finally task 302C). In some examples, a creator may define a desired sequence by specifying “sequential” or an explicit sequence (e.g., task 302B, then task 302C, and finally task 302A). In examples, the reasoning engine 114 may set the sequence to a default sequence (e.g., “sequential”) or may identify each task and set an optimal sequence for the tasks that produces an optimal result efficiently. In some cases, the reasoning engine 114 may set the sequence in the event that the creator does not specify one, or may prompt the creator to specify a sequence or select a preset one designed by the reasoning engine 114.

Returning to FIG. 1, reasoning engine 114, according to some examples, can employ an LLM to process the one or more queries provided by the interface 112 to generate the plurality of parameters characterizing tasks and an expected outputs of the each task. For example, the one or more queries can be received by the interface 112 as natural language queries. In one example, a creator may enter character strings into an input device of the client system 130, which are provided to the interface as the one or more queries. In another example, the one or more queries may be provided to the interface as spoken natural language, for example, as an audio file that the interface may process using a speech to text processing that converts spoken language to character strings. In another example, the spoken language may be provided to the LLM, for example, where the LLM is trained on audio files. In either case, the reasoning engine 114 may apply the natural language queries to the LLM, which can parse the natural language queries and generate the parameters that characterize the tasks and expected outputs. Each task can be assigned an agentic tool instance 115 based on the parameters, as described above.

After the project mesh 113 is constructed (e.g., configuration file 134 stored at client system 130), a mesh function can be executed that runs project mesh 113 by executing the configuration file 134 to perform the tasks and agentic tool instances set forth therein. Executing the mesh function can cause the set of agentic tool instances 115 to execute corresponding agentic tools at locations specified in the configuration file 134 to obtain results of each task. For example, a subsequent user (which may be the creator in some examples) may select to run the project mesh 113 by entering inquiries into the mesh function that provides, among other things, an identification of the specified project mesh 113 and a desired result. The inquiries can be provided to the interface 112, via an input device, and forwarded to the reasoning engine 114. The reasoning engine 114 may locates the project mesh 134 selected by the subsequent user in the agentic tool market place 116, for example, by parsing the inquiries in a manner similar to the one or more queries described above.

The reasoning engine 114 may then execute the project mesh 113 as a standalone product (e.g., a web application executable from a browser) in accordance the desired result. For example, the reasoning engine 114 may parse the inquires to discover which agentic tools specified in the configuration file 134 corresponding to the project mesh 113 are needed to provide the desired result. The reasoning engine 114 may then discover and activate the agentic tool instances 115 of identified agentic tools specified in the configuration file 134 in accordance with the description to return output results in accordance with the queried desired result. For example, the reasoning engine 114 may query manifests of each agentic tool instances 115 set forth in the configuration file 134 to locate agentic tools that are appropriate for the desired result. The reasoning engine 114 may then bind the discovered agentic tools to itself to enable their use. Each agentic tool instance 115 can then be activated in a sequence set forth in the configuration to access a corresponding agentic tools, which can be ran to execute a corresponding tasks as set forth in the configuration file 134 that embodies the project mesh 113. Each agentic tool may execute its task according to the defined order to supply an output. The outputs can be processed to provide the output result in accordance with the desired result as specified in the query.

In some examples, reasoning engine 114 can manage user authentication and authorization, such as, but not limited to, single sign-on (SSO), role-based access control (RBAC), and the like. For example, not all subsequent users should have creator permissions, and within a project, users may have restricted access to certain agentic tool instances or specific data (e.g., RAG tools may include several documents, but a user may only be allowed to access a subset). Thus, when a user attempts to access project mesh 113, reasoning engine 114 may first authenticate the user and authorize the user's access to the project mesh 113, as well as on a per-agentic tool instance basis.

Client system 130 may be configured to generate, transmit, and receive data from platform 110. Client system 130 may be one or more end user devices, sensors, or software systems. In an example, client system 130 may be operated by a creator during a project that seeks to create project mesh 113. The client system 130 may comprise a number of end user devices operated by any number of persons that are involved in the project. Examples of client system 130 may include, but are not limited to, desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, netbook computers, personal digital assistants (PDAs), mobile phones, smartphones, smart terminals, dumb terminals, virtual terminals, virtual assistants, and the like.

Like the client system 130, third party tool creator systems 140 may be configured to generate, transmit, and receive data from platform 110 and may be implemented as any one or more of the devices described above.

The network 120 may be a public or private network, such as the Internet, or another communication network to allow connectivity among components of system 100. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers. Such devices need not be directly part of the system 100, but may facilitate communication between the various components of the system 100 and between the components of the system 100 and other network-connected entities.

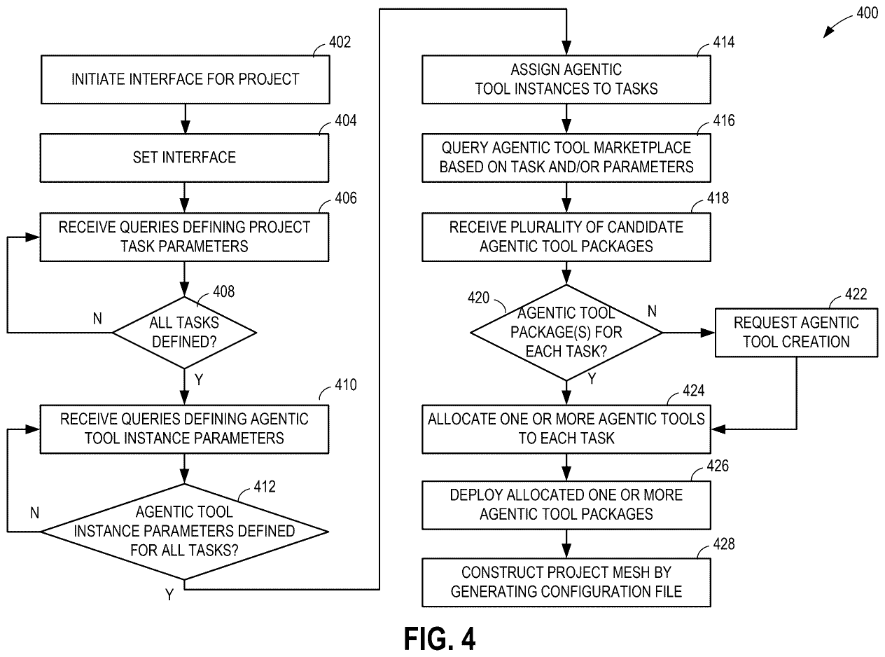

FIG. 4 illustrates an example process for creating a project mesh, in accordance with the examples disclosed herein. In examples, process 400 may be implemented as machine-readable instructions that may cause a processor to perform the operations described herein. In some examples, platform 110 of FIG. 1 may be implemented to execute one or more operations disclosed herein.

At operation 402, a project can be initiated, for example, at a client system 130. In examples, the project may be defined with a purpose of creating a project mesh (e.g., project mesh 113) via the platform 110. The client system 130, for example, may be operated by one or more creators. Operation 402 may comprise executing an API call that connects a client system (e.g., client system 130) to platform 110 via an interface (e.g., interface 112). In some examples, operation 402 may comprise inputting one or more queries into a GUI on the client system. In examples, operation 402 may initialize a configuration file, for example, by retrieving a template file that can be populated with information during process 400.

At operation 404, one or more LLM types may be set for the project mesh. For example, the client system may select an LLM type (e.g., the GPT series of models, Gemini, the LLaMA family of models, Granite models, Claude models, and Mistral AI's models, to name a few examples) that may be used by the agentic tool. In examples, as described above, the selected LLM type may be entered into the configuration file.

At operation 406, one or more queries can be received that define tasks of the project. For example, client system may input one or more queries, which may be received by the interface. The interface may provide the one or more queries to a reasoning engine (e.g., reasoning engine 114) that generates a plurality of first parameters defining tasks of the project. As described above, the plurality of first parameters may comprise sets of task parameters, each of which can be used to define a task. For example, each set of task parameters may include a first one or more parameters representative of a task description and a second one or more parameters descriptive of expected outputs for a task.

At operation 408, a determination is made as to whether all tasks have been defined. For example, the reasoning engine may prompt the client system, via the interface, as to whether or not all desired tasks have been queried. In some examples, the reasoning engine can assist with defining tasks by rephrasing the queries (e.g., prompt engineering) to enhance clarity and by posing questions via prompts presented on a dashboard at the client system to stimulate further parameters and illicit additional queries from the client system. If the determination at operation 408 is negative, the process repeats operation 406 until all tasks are defined.

At operation 410, one or more queries can be received that define agentic tool parameters for each task of the project. For example, client system may input one or more queries, which may be received by the interface. These queries may be included with queries used in operation 406 and/or as separate queries. Furthermore, operations 410 and 406 may be performed in parallel, in the order shown in FIG. 4, or in other another order depending on the implementation and queries submitted to the interface. In any case, the interface may provide the one or more queries to the reasoning engine that generates a plurality of second parameters that can be used to define the set of agentic tool instances (e.g., agentic tool instances 115). For example, as described above, the plurality of second parameters may comprise sets of agentic tool instances parameters, each of which can be used to define (e.g., construct) a manifest for an agentic tool instance. As an illustrative example, each set of agentic tool instance parameters may include a first one or more parameters representative of a role for an agent, a second one or more parameters representative of a goal for the agent, and a third one or more parameters representative of a backstory for the agentic tool instance.

At operation 412, a determination is made as to whether agentic tool instance parameters have been defined for all tasks. For example, the reasoning engine may prompt the client system, via the interface, as to whether or not all desired tasks have been queried. In another example, the reasoning engine may confirm that the agentic tool instance parameters define a number of agentic tool instances equal to the number of defined tasks. In some examples, the reasoning engine can assist with defining agentic tool instance parameters by rephrasing the queries (e.g., prompt engineering) to enhance clarity and by posing questions via prompts presented to the client system that stimulate further parameters and illicit additional queries from the client system. The reasoning engine may provide detailed explanations of available roles and backstories (e.g., meanings) to help assign each agentic tool instance to the correct task (e.g., operation 414). If the determination at operation 412 is negative, the process repeats operation 412 until all agentic tool instance parameters are defined for each task.

At operation 416, each task defined in operation 406 is assigned agentic tool instance parameters defined in operation 410. For example, the plurality of second parameters generated at operation 410 may be used by the reasoning engine to define agentic tool instances, which can be assigned to tasks according a correspondence with the plurality of first parameters generated at operation 406. That is, for example, each set of agentic tool instance parameters can be assigned to a set of task parameters of the plurality of first parameters according to relation between the agentic tool instance parameters and the task parameters. For example, an agentic tool instance can be assigned to a task in which the role corresponds to (e.g., is substantially related to or otherwise similar to) the description of the task and the goal corresponds to the expected output of the task. In some cases, the role and the description may be the substantively the same, and the goal and the expected output may be substantively the same.

At operation 416, an agentic tool market place (e.g., agentic tool market place 116) is queried to discover agentic tool packages based on the task and/or agentic tool instance parameters. For example, the reasoning engine may query the agentic tool market place to discover candidate agentic tool packages using the task and/or agentic tool instance parameters (e.g., the plurality of first parameters and/or the plurality of second parameters). In this case, the reasoning engine may access the agentic tool market place and locate one or more of agentic tool packages that may be achieve an expected output in performing a defined task.

At operation 418, a plurality of candidate agentic tool packages may be received. The plurality of candidate agentic tool packages may comprise a listing of one or more agentic tools, from the agentic tool market place, applicable to each defined task. The plurality of candidate agentic tool packages may be provided as a listing of references to the various agentic tools. The reference to each candidate agentic tool may include, among other things, a name or other identifier of the candidate agentic tools and a location at which the candidate agentic tools can be accessed and executed. In examples, the location may be provided as an IP address, a file location, or similar pointers. The plurality of candidate agentic tool packages may be provided as a listing of references containing this information for locating and executing each respective agentic tool at a specified location.

At operation 420, a determination is made as to whether at least one agentic tool was located for each task defined at operation 406. If the determination is negative (e.g., there is no agentic tool package in the agentic tool market place that can perform the defined task to achieve the expected output), the process 400 proceeds to operation 422 and submits feedback to the agentic tool market place requesting a new agentic tool be created for the defined task. This request may be picked up by another agentic tool creator (e.g., a third party agentic tool creator system), who may setup a project to create the requested agentic tool. The new agentic tool may be created through another iteration of process 400, in some examples.

At operation 424, one or more agentic tools of the plurality of candidate agentic tool packages from operation 418 can be allocated to each defined task as one or more agentic tools. In an example, the reasoning engine may select one or more optimal agentic tools as one or more agentic tool packages for a given task, for example, in accordance with the plurality of first and/or second parameters. In another example, reasoning engine may forward the plurality of candidate agentic tool packages to the client system, via interface, for selection. In examples where an agentic tool was not located for a particular task (e.g., operation 422), the task may not be allocated an agentic tool, leaving the allocation open for once an agentic tool becomes available.

The allocated agentic tool packages can be deployed (operation 426) and the project mesh can be constructed (operation 428) by populating the configuration with parameters defined during process 400.

For example, operation 426 can include deploying each of the allocated agentic tool packages as an agentic tool instance. As described above, deploying an agentic tool package may include updating default settings specified by the third party tool creator based on the agentic tool instance parameters defined in operation 412. The agentic tool instance parameters may be used to construct a manifest for each be agentic tool. Operation 426 may also include allocating resources that may be necessary to run the allocated agentic tools and exposing API endpoints and UIs (if any), as defined by the third party creator.

The deployed agentic tool instances may be bound to the project mesh, for example, by populating the configuration file at operation 428. For example, operation 428 may include configuring a mesh of agentic tools comprising the set of agentic tool instances, defined in operation 410 and assigned to tasks at operation 414, which can access and execute corresponding agentic tools, allocated at operation 424. The configuration file can be stored at the client system as the project mesh. For example, the set of agentic tool instances and corresponding agentic tools may define the project mesh. Configuring the project mesh may include building the configuration file (e.g., an example of which is shown in FIG. 3), for example, by populating fields of the configuration file using the plurality of first and second parameters. Portions of the configuration corresponding to each agentic tool instance can be populated with information for accessing and executing a corresponding agentic tool.

Operation 428 may also include configuring delegation permissions for each agentic tool instance. For example, each agentic tool instance can be permitted to delegate its role and/or goal to another agentic tool instance based on creator preferences. The delegation permissions (TRUE or FALSE) may be generated from queries received at the interface. These queries may be received earlier in the process (e.g., at one of operations 402, 406, 410, or 424) or after the project mesh is configured.

Operation 428 may also include configuring a sequence in which each task is to be performed. For example, a sequence can be defined at the client system via queries and/or selected by the reasoning engine. In some examples, a creator may define a desired sequence by specifying “sequential” or other explicit sequence. In examples, the reasoning engine may set the sequence to a default sequence or may identify each task and set an optimal sequence for the tasks that produces an optimal result efficiently. In some cases, the reasoning engine may configure the sequence in the configuration file if client system does not specify one, or may prompt the client system to specify a sequence or select a preset one designed by the reasoning engine.

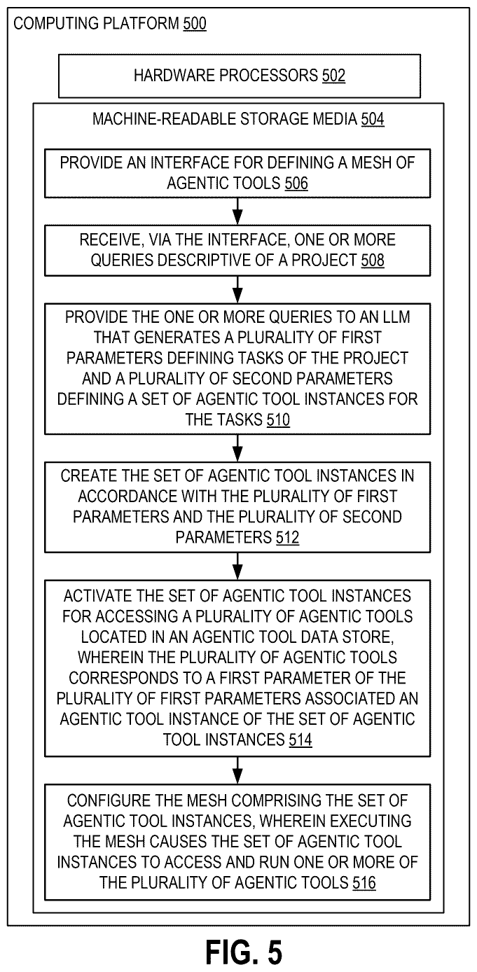

FIG. 5 illustrates a computing component that may be used to create a project mesh in accordance with various examples of the disclosed technology. Referring now to FIG. 5, computing component 500 may be, for example, a server computer, a controller, or any other similar computing component capable of processing data. In the example implementation of FIG. 5, the computing component 500 includes a hardware processor 502 and machine-readable storage medium for 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-516, to control processes or operations of the Agentic Tool Mesh platform (e.g., platform 110 of FIG. 1). As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-516.

Hardware processor 502 may execute instruction 506 to provide an interface for defining a mesh of agentic tools. In some examples, the interface may be implemented as interface 110 on platform 110 of FIG. 1, which can be used to define project mesh 113 of agentic tool instances 115.

Hardware processor 502 may execute instruction 508 to receive, via the interface, one or more queries descriptive of a project. In some examples, the one or more queries are provided to the interface as a character string in human understandable natural language.

Hardware processor 502 may execute instruction 510 to provide the one or more queries to an LLM that generates a plurality of first parameters defining tasks of the project and a plurality of second parameters defining a set of agentic tool instances for the tasks. In examples, the LLM may be part of a reasoning engine (e.g., reasoning engine 114 of FIG. 1), which can be used to define a task as described above in connection with FIG. 1. In examples, the LLM comprises natural language processing. In this case, according to some examples, the LLM generates the plurality of first parameters and the plurality of second parameters by parsing the one or more queries using the natural language processing and populating a configuration file with the plurality of first parameters and the plurality of second parameter.

Hardware processor 502 may execute instruction 512 to create the set of agentic tool instances in accordance with the plurality of first parameters and the plurality of second parameters. For example, as described above in connection with FIGS. 1-4, a builder (e.g., builder 117 and/or 217 described above may use the plurality of first parameters and/or the plurality of second parameters to discover agentic tool packages from an agentic tool market place, select one or more agentic tool packages for each task, and deploy the selected agentic tools as agentic tool instances.

Hardware processor 502 may execute instruction 514 to activate the set of agentic tool instances for accessing a plurality of agentic tools located in an agentic tool data store. That is, for example, instructions 514 may include deploying agentic tool packages allocated to a defined task as agentic tool instances, as described above in connection with FIGS. 1-4. In examples, the plurality of agentic tools corresponds to a first parameter of the plurality of first parameters associated an agentic tool instance of the set of agentic tool instances. In some examples, the plurality of agentic tools comprise domain-specific agentic tools. In another example, the plurality of agentic tools comprises at least a domain-specific LLM.

Hardware processor 502 may execute instruction 516 to configure the project mesh comprising the set of agentic tool instances, wherein executing the project mesh causes the set of agentic tool instances to access and run one or more of the plurality of agentic tools. In some examples, instruction 516 may include populating a configuration file with a prompt corresponding to each of the one or more queries into one of a plurality of fields. Further examples of configuring the project mesh and populating the configuration file are provided above in connection with FIGS. 1-4.

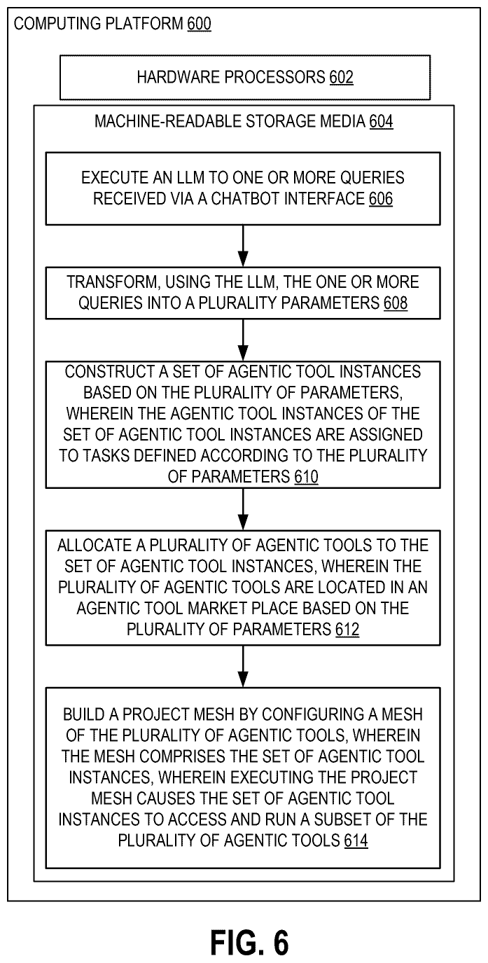

FIG. 6 illustrates a computing component that may be used to implement functionality of the agentic tool mesh platform in accordance with various examples of the disclosed technology. Referring now to FIG. 6, computing component 600 may be, for example, a server computer, a controller, or any other similar computing component capable of processing data. In the example implementation of FIG. 6, the computing component 600 includes a hardware processor 602 and machine-readable storage medium for 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-614, to control processes or operations of the agentic tool mesh platform (e.g., platform 110 of FIG. 1). As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-614.

Hardware processor 602 may execute instruction 606 to execute an LLM to one or more queries received via a chatbot interface. For example, a reasoning engine (e.g., reasoning engine 114 of FIG. 1) can be provided that comprises the LLM having a chabot interface, as described above in connection with FIG. 1.

Hardware processor 602 may execute instruction 608 to transform, using the LLM, the one or more queries into a plurality parameters. In some examples, as described above in connection with FIGS. 1-4, the plurality of parameters comprises sets of task parameters and sets of agentic tool instance parameters. In this case, instructions 608 may include further instructions to generate the tasks in accordance with the set of task parameters, and the set of agentic tool instances can be constructed based on the set of agentic tool instance parameters. The set of agentic tool instances can be assigned to the tasks based on correspondence between the sets of task parameters and the sets of agentic tool instance parameters.

In some examples, the one or more queries are provided to the chatbot interface as a character string in human understandable natural language. In this case, the LLM can generate the plurality of parameters by parsing the one or more queries using natural language processing and populating a configuration file with the plurality parameters.

Hardware processor 602 may execute instruction 610 to construct a set of agentic tool instances based on the plurality of parameters. In examples, the agentic tool instances of the set of agentic tool instances are assigned to tasks defined according to the plurality of parameters. For example, a builder (e.g., builder 117 and/or builder 217) may be employed to construct the set of agentic tool instances based on the plurality of parameters received from a reasoning engine (e.g., reasoning engine 114), as described above in connection with FIGS. 1-4.

Hardware processor 602 may execute instruction 612 to allocate a plurality of agentic tools to the set of agentic tool instances. In examples, the plurality of agentic tools are located in an agentic tool market place based on the plurality of parameters. In some examples, a builder may use the plurality of parameters to discover agentic tool packages that can be allocated and deployed as agentic tool instances, as described above in connection with FIGS. 1-4. In some examples, the plurality of agentic tools comprise domain-specific agentic tools, domain-specific LLM, and other tools as described above in connection with FIG. 1.

Hardware processor 602 may execute instruction 612 to build a project mesh by configuring a mesh of the plurality of agentic tools. In examples, the project mesh comprises the set of agentic tool instances, and executing the project mesh causes the set of agentic tool instances to access and run a subset of the plurality of agentic tools. As an example, the project mesh can be built by populating a configuration file, as described above in connection with FIGS. 1-4.

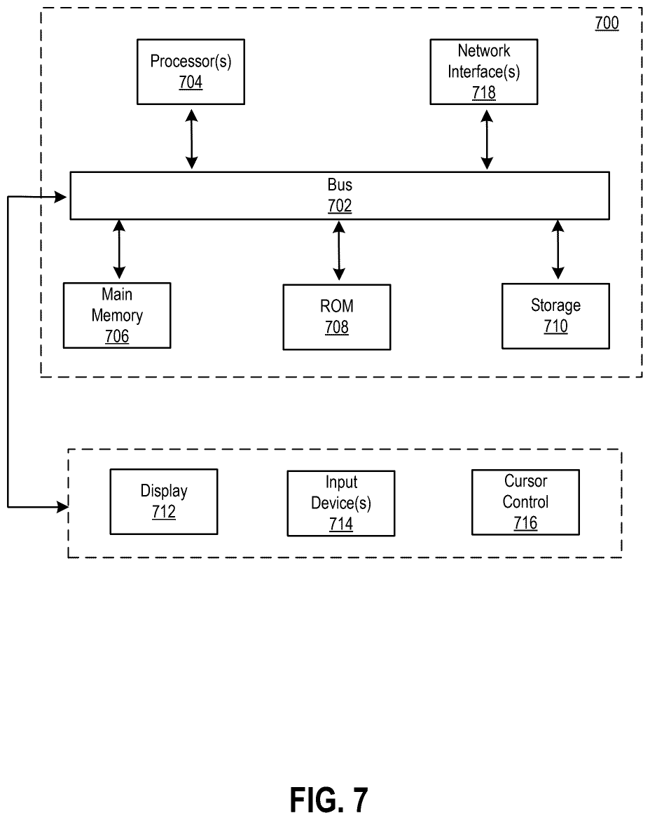

FIG. 7 depicts a block diagram of an example computer system 700 in which various examples of the disclosed technology described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors. The computer system 7000 may be implemented as one or more component of the system 100 described in connection with FIG. 1. For example, computer system 7000 may be implemented as client system 130, third party tool creator systems 140, and/or platform 110.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions. For example, main memory 706 may store instructions, that when executed by processor(s) 704, cause computer system 700 to perform one or more of the operations described in connection with FIG. 4.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a network interface 718 (also referred to as a communication interface) coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 718, which carry the digital data to and from computer system 700, are example forms of transmission media.

The computer system 700 can send messages and receive data, including program code, through the network(s), network link and network interface 718. In the Internet example, a server might transmit a requested code for an application program through the Internet, the ISP, the local network and the network interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
providing an interface for defining a mesh of agentic tools;
receiving, via the interface, one or more queries descriptive of a project;
providing the one or more queries to a large language model (LLM) that generates a plurality of first parameters defining tasks of the project and a plurality of second parameters defining a set of agentic tool instances for the tasks;
creating the set of agentic tool instances in accordance with the plurality of first parameters and the plurality of second parameters;
activating the set of agentic tool instances for accessing a plurality of agentic tools located in an agentic tool data store, wherein the plurality of agentic tools corresponds to a first parameter of the plurality of first parameters associated an agentic tool instance of the set of agentic tool instances; and
configuring the mesh comprising the set of agentic tool instances, wherein executing the mesh causes the set of agentic tool instances to access and run one or more of the plurality of agentic tools.

2. The method of claim 1, wherein the plurality of agentic tools comprise domain-specific agentic tools.

3. The method of claim 1, wherein the plurality of agentic tools comprises at least a domain-specific LLM.

4. The method of claim 1, wherein the one or more queries are provided to the interface as a character string in human understandable natural language.

5. The method of claim 1, further comprising:
populating a configuration file with a parameter responsive to a prompt corresponding to each of the one or more queries into one of a plurality of fields.

6. The method of claim 1, wherein the LLM comprises natural language processing.

7. The method of claim 6, wherein the LLM generates the plurality of first parameters and the plurality of second parameters by parsing the one or more queries using the natural language processing and populating a configuration file with the plurality of first parameters and the plurality of second parameters.

8. A system, comprising:
a memory storing instructions; and
a processor communicably connected to the memory and configured to execute the instructions to:
provide an interface for defining a mesh of agentic tools;
receive, via the interface, one or more queries descriptive of a project;
provide the one or more queries to a large language model (LLM) that generates a plurality of first parameters defining tasks of the project and a plurality of second parameters defining a set of agentic tool instances for the tasks;
create the set of agentic tool instances in accordance with the plurality of first parameters and the plurality of second parameters;
activate the set of agentic tool instances for accessing a plurality of agentic tools located in an agentic tool data store, wherein the plurality of agentic tools corresponds to a first parameter of the plurality of first parameters associated an agentic tool instance of the set of agentic tool instances; and
configure the mesh comprising the set of agentic tool instances, wherein executing the mesh causes the set of agentic tool instances to access and run one or more of the plurality of agentic tools.

9. The system of claim 7, wherein the plurality of agentic tools comprise domain-specific agentic tools.

10. The system of claim 7, wherein the plurality of agentic tools comprises at least a domain-specific LLM.

11. The system of claim 7, wherein the one or more queries are provided to the interface as a character string in human understandable natural language.

12. The system of claim 7, wherein the processor is further configured to execute the instructions to:
populate a configuration file with a prompt corresponding to each of the one or more queries into one of a plurality of fields.

13. The system of claim 7, wherein the LLM comprises natural language processing.

14. The system of claim 13, wherein the LLM generates the plurality of first parameters and the plurality of second parameters by parsing the one or more queries using the natural language processing and populating a configuration file with the plurality of first parameters and the plurality of second parameters.

15. A non-transitory computer-readable storage medium storing instructions that, when executed by a processor, cause the processor to:
execute a large language model (LLM) to one or more queries received via a chatbot interface;
transform, using the LLM, the one or more queries into a plurality parameters;
construct a set of agentic tool instances based on the plurality of parameters, wherein the agentic tool instances of the set of agentic tool instances are assigned to tasks defined according to the plurality of parameters;
allocate a plurality of agentic tools to the set of agentic tool instances, wherein the plurality of agentic tools are located in an agentic tool market place based on the plurality of parameters; and
build a project mesh by configuring a mesh of the plurality of agentic tools, wherein the mesh comprises the set of agentic tool instances, wherein executing the project mesh causes the set of agentic tool instances to access and run a subset of the plurality of agentic tools.

16. The non-transitory computer-readable storage medium of claim 15, the plurality of parameters comprises sets of task parameters and sets of agentic tool instance parameters, wherein the non-transitory computer-readable storage medium stores further instructions that, when executed by a processor, cause the processor to:
generate the tasks in accordance with the set of task parameters, wherein the set of agentic tool instances are constructed based on the set of agentic tool instance parameters; and
assign the set of agentic tool instances to the tasks based on correspondence between the sets of task parameters and the sets of agentic tool instance parameters.

17. The non-transitory computer-readable storage medium of claim 15, wherein the plurality of agentic tools comprise domain-specific agentic tools.

18. The non-transitory computer-readable storage medium of claim 15, wherein the plurality of agentic tools comprises at least a domain-specific LLM.

19. The non-transitory computer-readable storage medium of claim 15, wherein the one or more queries are provided to the chatbot interface as a character string in human understandable natural language.

20. The non-transitory computer-readable storage medium of claim 19, wherein the LLM generates the plurality of parameters by parsing the one or more queries using natural language processing and populating a configuration file with the plurality parameters.
